(19) United States
(12) Patent Application Publication
(10) Pub. No.: US 2009/0113785 A1
(43) Pub. Date: May 7, 2009

(54) Fish hook

(76) Inventor: Nick Michael Nomikos, Los Angeles, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/979,608

(22) Filed: Nov. 6, 2007

(51) Int. Cl. A01K 91/04

(52) U.S. Cl. 43/44.83

(57) ABSTRACT

The fish hook has an arcuate hook and an elongate shank extending from the arcuate hook. The shank has a linear portion extending from the hook and the end of the shank opposite the hook is formed as a helical coil having an axial center that extends substantially parallel to or in-line with the linear portion of the shank. The diameter of the coil progressively decreases as the coil extends to the end of the shank opposite the hook. A knotted fish line can be looped into the coil which coil has adequate space for the line to pass through. The knotted line is caught up in the coil after it is pulled to secure the fishhook to the fish line. In a similar manner, a helical coil may be manufactured on any fishing tackle to provide easy attachment and removal of the tackle to a knotted fishing line.

### BACKGROUND OF THE INVENTION

1. Field of the Invention

The present invention relates to fishing equipment, and particularly to a fish hook or other tackle that terminates in a helical coil for fastening to a knotted flexible line.

2. Description of the Related Art

Fish hooks of a variety of designs and configurations have been tried in the art of fishing. More specifically, fish hooks of existing designs and configurations fall short of providing an easy means of connecting to a fish line. Known line connecting methods generally consist of various tedious manipulations of the fish line about the fish hook, which require good eye-hand coordination, sharp vision and nimble dexterity.

Thus, a fish hook solving the aforementioned problems is desired.

### SUMMARY OF THE INVENTION

The fish hook has an arcuate hook and an elongate shank. The elongate shank extends from the arcuate hook. The end of the shank opposite the hook is formed as a helical coil having an axial center that runs substantially parallel to or in-line with the linear portion of the shank. Advantageously, the diameter of the turns of the helical coil progressively decrease as the coil extends towards the end of the shank opposite the hook. A knotted fish line can be looped around and into the coil, the coil having adequate space for the line to pass through during the looping procedure. The knotted line is caught up in the coil after it is pulled to secure the fishhook to the fish line.

These and other features of the present invention will become readily apparent upon further review of the following specification and drawings.

### BRIEF DESCRIPTION OF THE DRAWINGS

FIG. 1 is a perspective view of the fish hook according to the present invention.

FIG. 2 is a partial environmental perspective view of the fish hook according to the present invention showing how a fish line is fed into the coil at the end of the shank.

FIG. 3 is an environmental perspective view of the fish hook according to the present invention with the fishing line attached and knotted.

Similar reference characters denote corresponding features consistently throughout the attached drawings.

### DETAILED DESCRIPTION OF THE PREFERRED EMBODIMENT

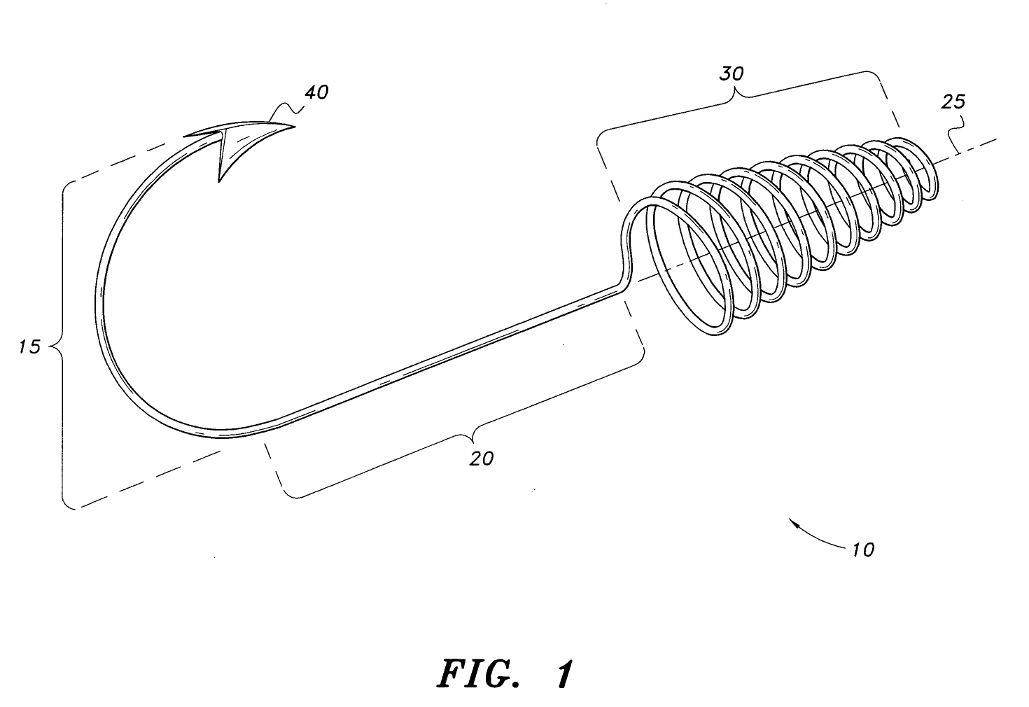

As shown in FIG. 1, the present invention is a fish hook 10 having an arcuate hook 15 and an elongate shank 20 extending from the arcuate hook 15. The end of the shank 20 opposite the hook 15 is formed as a helical coil, and, as shown in FIG. 1, has an axial center 25 that extends substantially parallel to or in-line with the substantially linear portion of shank 20. As is generally known in the art, a barb 40 may extend from the tip of arcuate hook 15.

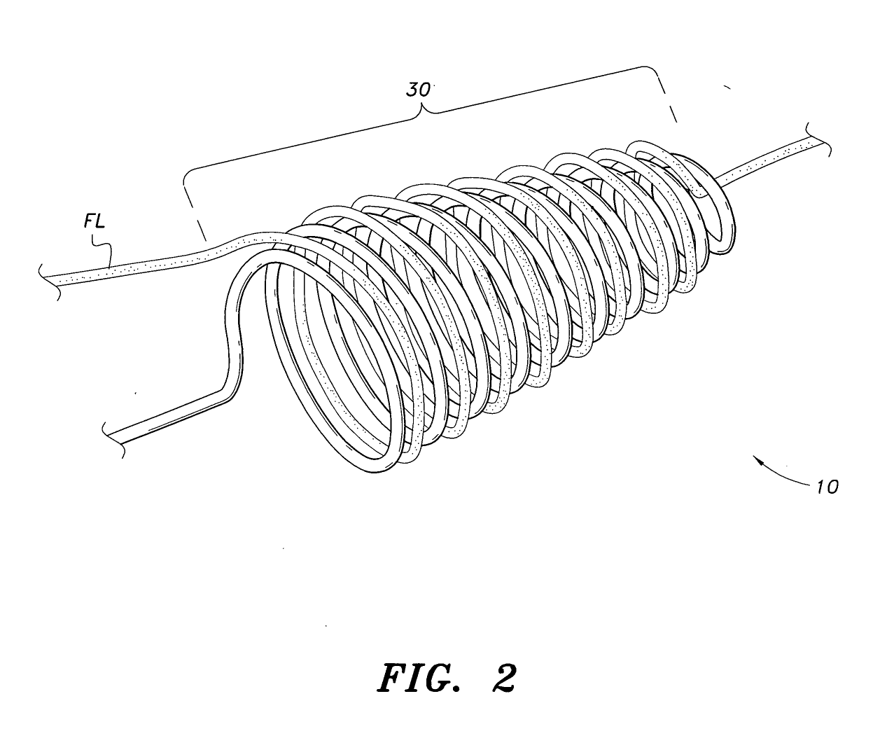

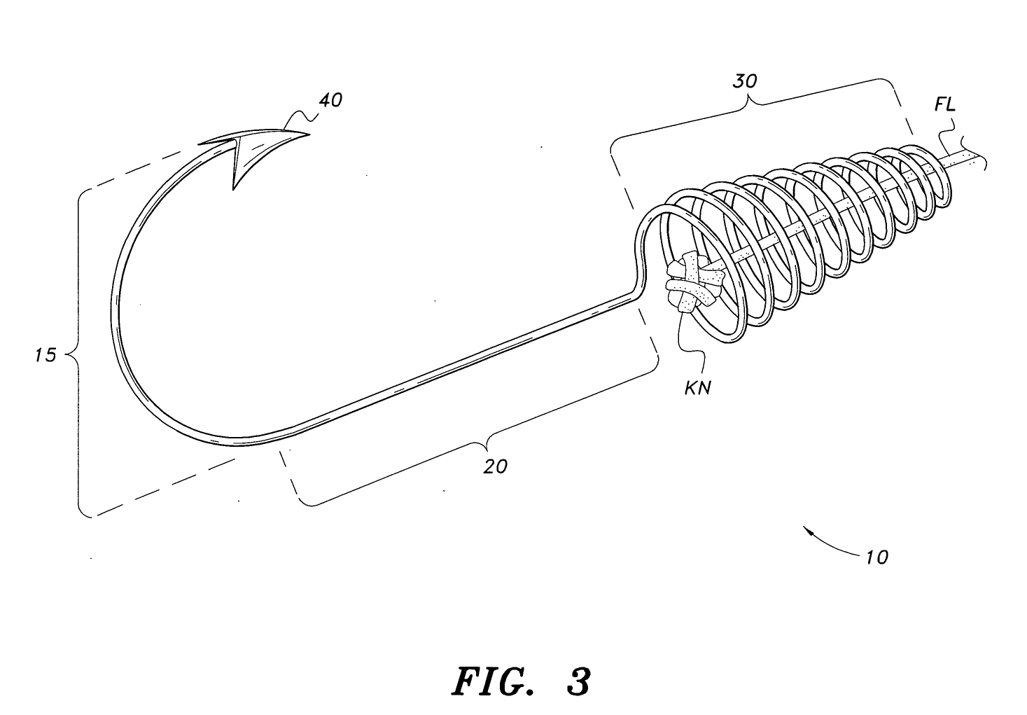

The diameter of helical coil 30 progressively decreases as the coil 30 extends towards the end of the shank 20 opposite hook 15. As shown in FIG. 2, a fish line FL can be looped into the coil because the coil turns have adequate space between them for the line to pass through. As shown in FIG. 3, a knot KN can be formed at the end of the fish line FL, so that, subsequent the aforementioned looping procedure, the knot KN of fish line FL may be caught up in the coil to secure the fishhook 10 to the fish line FL. It should be understood that when removal of the fish line FL is desired, after relieving tension in the fish line FL, the fish line FL can be easily unlooped out of the coil because the coil turns have adequate space between them for the line to pass through. The helical coil 30 may be disposed on other fishing tackle, such as a bobber or the like, to achieve the same effect of securing the fishing tackle to a fishing line FL.

It is to be understood that the present invention is not limited to the embodiment described above, but encompasses any and all embodiments within the scope of the following claims.

I claim:

1. A fish hook, comprising:
an arcuate hook; and
an elongate shank extending from the arcuate hook, the shank having a substantially linear portion and an end opposite the hook formed into a helical coil, the coil having turns of progressively smaller diameter extending from the linear portion to the end opposite the hook;
whereby a fishing line terminating in a knot is adapted for being snagged within the turns of the coil in order to secure the fish hook to the fishing line.

2. The fish hook according to claim 1, wherein said helical coil defines a central axis extending parallel to the linear portion of said shank.

3. The fish hook according to claim 1, wherein said helical coil defines a central axis extending substantially in-line with the linear portion of said shank.

4. The fish hook according to claim 1, wherein said arcuate hook terminates in a sharp point and comprises a barb at the sharp point.

5. A fishing tackle, comprising:
an article of fishing tackle;
a helical coil extending from the article of fishing tackle, the coil having turns of progressively smaller diameter extending away from the article of fishing tackle, the coil being adapted for snagging a knot in a fish line in order to attach the article of fishing tackle to the fish line.
